(19) United States
(12) Patent Application Publication
(10) Pub. No.: US 2007/0262772 A1
(43) Pub. Date: Nov. 15, 2007

(54) Method and apparatus for correcting magnetic flux sensor signals

(76) Inventors: John P. Rogers, Houston, TX (US); Simon J. Ward, Spring, TX (US)

Correspondence Address: Loren G. Helmreich;Browning Bushman P.C., Suite 1800, 5718 Westheimer, Houston, TX, 77057, US

(21) Appl. No.: 11/430,572

(22) Filed: May 9, 2006

(51) Int. Cl. G01N 27/82

(52) U.S. Cl. 324/240

(57) ABSTRACT

Apparatus for detecting defects in an oilfield string at a well site as the string is pulled from the well include a plurality of magnetic flux sensors 12 circumferentially spaced about the string, and a plurality of stand-off sensors 14 circumferentially spaced about the string for determining changes in stand-off distance between one or more stand-off sensors and an external surface of the string. Computer 18 corrects signals from the plurality of magnetic flux sensors as a function of the detected stand-off distance.

### FIELD OF THE INVENTION

The present invention relates to techniques for detecting defects in metallic string, and more particularly in production tubulars and sucker rod strings when pulled from a production well. The technique particularly relates to utilizing magnetic flux sensors to detect defects, and to correcting signals from magnetic flux sensors at a well site to better determine the nature and extent of the defect.

### BACKGROUND OF THE INVENTION

Most sensors directly measure the physical property of interest. Magnetic sensors, however, detect changes or disturbances in magnetic fields that have been created or modified. From those changes or disturbances, one can derive information on properties, such as direction, presence, rotation, or electrical currents. Earth's field or medium-field sensors have a magnetic range which is the earth's magnetic field to determine compass headings for navigation. Medium-field sensors include a flux-gate magnetometer, and anisotropic magneto-resistive (AMR), a Reed switch, sensors which use N-type silicone or Ga A, and Giant Magneto Resistive (GMR) devices. GMR sensors may sense the magnetic field strength over a wide range of fields. Since the GMR is able to detect the magnetic field rather than the change in magnetic field, they are useful as AC field sensors.

Various types of sensors have been used for detecting defects in oilfield tubulars, including production tubing, casing, and sucker rod strings which reciprocate or rotate to drive a downhole pump. The purpose of many of these sensors is to determine the presence and magnitude of defects in the tubing or sucker rod strings, so that joints with such defects can be replaced, and further measures taken to reduce the number and severity of the defects.

The output of a magnetic flux sensor, when used in an induced magnetic field to perform detection or evaluation of flaws in a ferro-magnetic object, is inversely proportional to the square of the distance from the surface of the object. In performing flaw detection and evaluation, the surface of the object under examination is often subject to movement relative to the sensor such as that incurred from irregular object shape or geometry, lack of centralization, surface roughness, or other factors which may change the surface-to-sensor distance. Conditions that result in an irregular shape or geometry of an object, lack of centralization, and surface roughness are commonly encountered when detecting defects in oilfield tubular goods, particularly when such defects are determined at the well site. If the relative stand-off of the production string or sucker rod string changes, a random source of sensor amplitude error will be introduced into all magnetic flux measurements.

This relative movement between the object being analyzed and the magnetic flux sensor significantly complicates the determination of the relative importance of flaws detected with said sensors, since the signals may be a result of both relative flaw severity as well as the distance from the sensor to the surface of the object under examination.

The disadvantages of the prior art are overcome by the present invention, and an improved method and apparatus is hereinafter disclosed for correcting signals from magnetic flux sensors at the well site when sensing oilfield tubular defects.

### SUMMARY OF THE INVENTION

In one embodiment, an apparatus for detecting defects in an oilfield tubular string at a well site as the string is pulled from a well comprises a plurality of magnetic flux sensors circumferentially spaced about the string at the well site, and a plurality of laser stand-off sensors for determining changes in a stand-off distance between the one or more magnetic flux sensors and an external surface of the string. A computer is used for correcting signals from a plurality of magnetic flux sensors is a function of the detected stand-off distance.

According to one embodiment of a method of the invention, defects in oilfield tubular strings are determined at a well site as a string is pulled from the well. Defects are sensed with a plurality of magnetic flux sensors circumferentially spaced about the string at the well site. Changes in the stand-off distance between the one or more magnetic flux sensors and an external surface of the string are also detected. A computer may be used for processing signals from a plurality of magnetic flux sensors as a function of the detected stand-off distance.

These and further features and advantages of the present invention will become apparent from the following detailed description, wherein reference is made to the figures in the accompanying drawings.

### BRIEF DESCRIPTION OF THE DRAWINGS

FIG. 1 is a simplified view of a tubular string at a well site, with a plurality of upper magnetic sensors, a plurality of intermediate magnetic sensors, and a plurality of lower laser stand-off sensors for collectively measuring defects in the string and correcting defect signals as a function of a detected send-off distance.

FIG. 2 is a schematic view of the intermediate and lower sensors positioned about a string, and the related hardware between the sensors and the computer.

FIG. 3 is a block diagram of the data collection and distribution system according to the invention.

FIG. 4 is a block diagram of a suitable laser triangulation sensor.

### DETAILED DESCRIPTION OF PREFERRED EMBODIMENTS

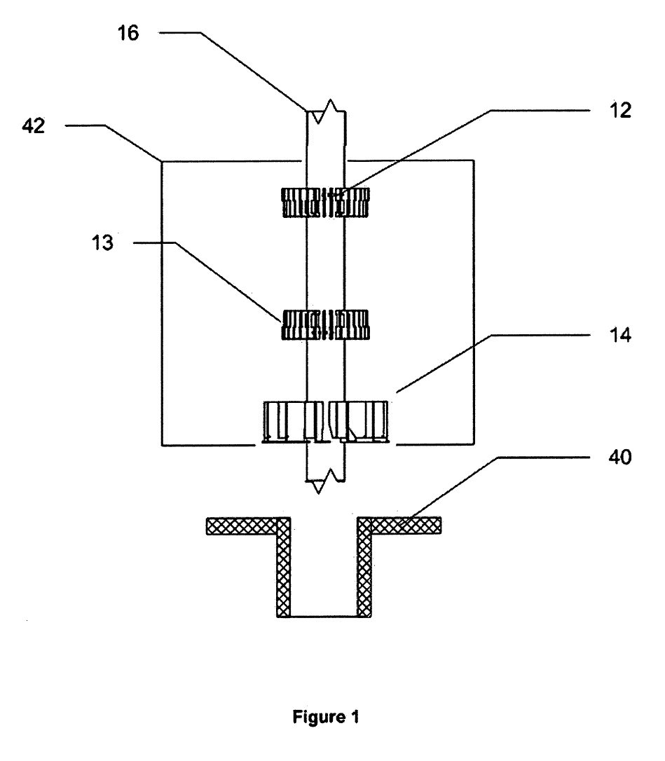

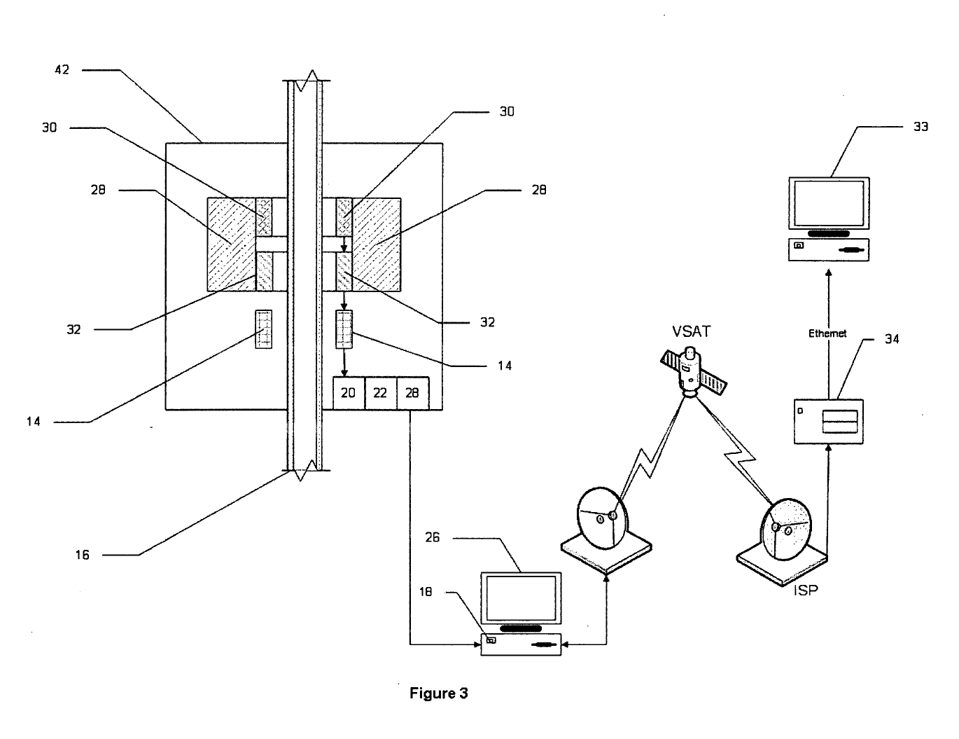

FIG. 1 illustrates one embodiment of the invention being used to detect defects in the production tubing string 16 as it is pulled from a well, and specifically through the top of wellhead 40 commonly provided at the surface of the well. The system of the present invention is thus able to detect defects in both the production tubing string and the sucker rod string, and to display the detected defects in real time to an operator at a well site as the string is pulled from the well. Those skilled in the art will appreciate that the magnetic flux sensors 12 as disclosed herein may also be used for detecting defects in other elongate metallic oilfield strings as they are pulled from the well site, including lengths of coiled tubing and larger diameter tubulars, such as casing. In a suitable embodiment, the magnetic flux sensor 12 may include a magnetic coil 28, a Hall Effect device 30, or a Giant Magneto-Resistor device 32, as shown in FIG. 3. The correction calculation may be performed using a computer 18, which may also process the output of sensors 12.

According to a preferred embodiment, a plurality of laser triangulation sensors 14 are used to measure the stand-off distance between the magnetic flux sensors circumferentially spaced about a string pulled from a well and the surface of the string being examined for flaws. More particularly, the spacing between the outer surface of the string and the sensors 14 is determined, and this spacing is the same as the spacing between the sensors 12 and 13 and the string due to the mounting of the sensor arrays. Even if this spacing is not the same between the string and sensor 12, 13, and 14, the spacing relationship is known and a corrective factor made by the computer.

A suitable laser triangulation sensor 14 may employ a CCD array 24, image dispersion optics 25, and signal processing algorithms. After determining the stand-off distance, a calculation is performed to correct the output of the magnetic flux sensor, as compared to the normalized output of other similar sensors, in computing the relative signal output. The output correction may be in the form of stand off based amplitude correction.

For examining a string coming out of a well, such as a tubing string or a sucker rod string, a plurality of circumferential stand-off sensors 14 displaced equally about the test article may be employed to compare and correct the output of the magnetic sensors as a function of the measured stand-off distance. A suitable laser sensor for this application is a laser triangulation sensor, such as the ACCU RANGE 200 laser displacement sensor supplied by Schmitt Measurement Systems, Inc. This sensor projects a beam of visible light that creates a spot on the target surface. Reflective light from the surface is viewed by a camera inside the sensor. The distance to the target is computed from the distance of the center of the spot to the incident laser beam.

FIG. 1 depicts a sensor array or package 42 for CSA flaw detection, for detecting splits and holes, and for diameter/stand-off centralization detection. Each of the upper sensors 12 (in the array 42) may include a radial and an axial Hall Effect sensor, with the sensors arranged uniformly circumferentially about the production tubing 16. FIG. 1 also depicts intermediate sensors 13, which may be radial Hall Effect or GMR sensors. These sensors 13 primarily detect splits or holes in the tubular 16. This intermediate set of sensors may include boards having a single GMR or HE device sensitive to radial flux leakage from the tubing under test. The lowermost group of sensors include a plurality of opposing laser triangulation sensors 14 for stand-off and centralization detection. All of these sensors may be provided on a sleeve which surrounds the production tubing 16, although the production tubing string is not necessarily centered within the sleeve.

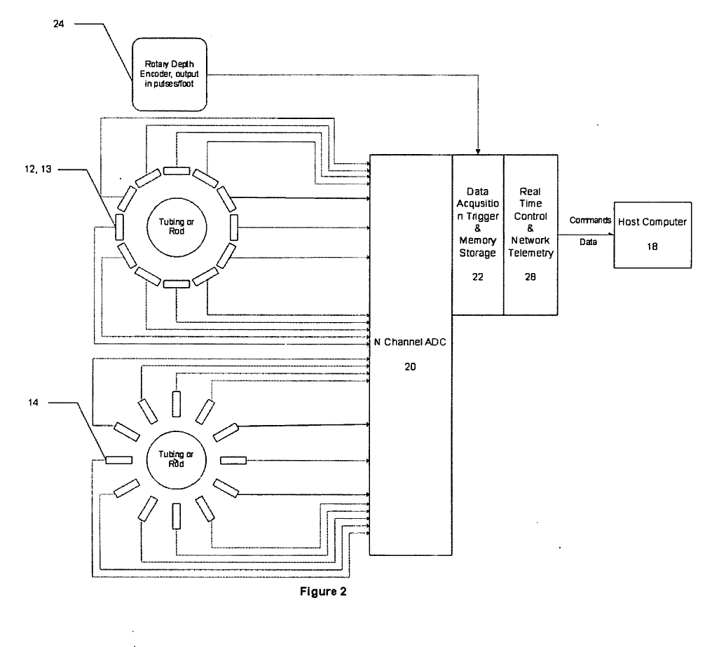

FIG. 2 depicts a plurality of magnetic flux sensors 12 circumferentially spaced about the production tubing or sucker rod 16. Offset sensors 14 are similarly positioned about the tubing or rod string 16. Signals from each of these sensors, correlated as a function of the circumferential position of the sensor and the depth of the string being analyzed, are forwarded to the computer 18. A synchronous multi-channel analog to digital converter 20 supplies information to the data acquisition and memory storage device 22. Also input to the triggering and storage device 22 are signals from a rotary depth encoder 24, which provides the depth synchronized ADC trigger by generating N pulses/foot of string extracted from the well. Depth resolution can be configured by the type of rotary depth encoder utilized. Digitized MFL, stand-off, and depth signals are temporarily stored in a memory buffer in device 22 then transferred by direct memory access to controller 28. The real time controller 28, then transfers the buffered signals to computer 18. Computer 18 may also accept configuration commands through the hardware as shown in FIG. 2 which may be transferred back to the controller 28, trigger 22, or ADC 20 and sensors 12, 14, thereby instructing the sensors to take particular measurements at certain depths or at certain points in time.

The transfer to the host computer 18 may be over a high speed ethernet connection. The pulses from the rotary depth encoder 24 may be also used to calculate synchronized depth in the controller 28, as MFL and stand-off information are captured, optionally using the work-over rig cabling to lift the string from the well.

FIG. 3 illustrates a block diagram of a system according to the present invention for reliably detecting defects in a tubular string, including the sensors 12, 13, and 14 discussed above. The information from each of these sensors arrays may be input to computer 18, where the information from the upper and intermediate sensors may be collected and correlated with the detected stand-off distance from the lower sensors. Data from each sensor may be correlated to the depth of the string in the well being examined, and also the circumferential position of each sensor about the string. Display 26 is provided for outputting a collective signal from the magnetic flux sensors. Signals for the computer 18 at the well site may be transferred by various telemetry systems to computer 33 at an office remote from the well site, and also to central storage computer 34 for data storage, so that the signals can be later compared to other wells or signals from the string subsequently pulled from the same well. Display 26 or another display may also be used for outputting a signal from the stand-off sensors and thus displaying the stand-off between the magnetic flux sensors and the external surface of the string.

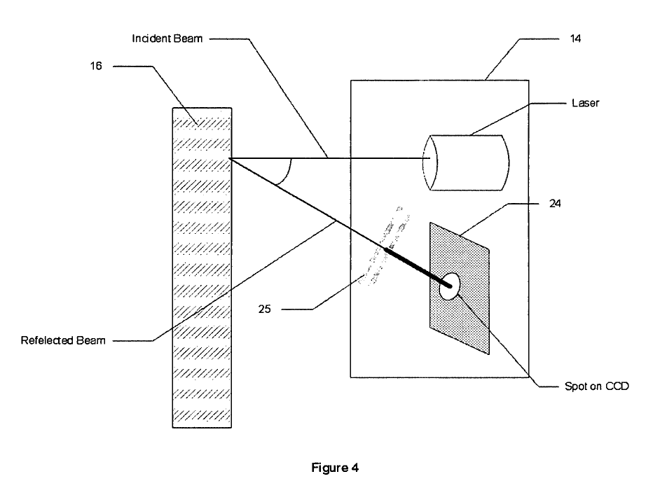

FIG. 4 simplistically depicts a suitable laser triangulation sensor which may be used according to the present invention to determine the axial spacing or standoff between the sensors and the outer surface of the rod or tubing being monitored. The laser transmits as incident beam to the exterior surface of tubing 16, and the reflected beam passes through image dispersion optics 25 to result in the spot on the surface of the CCD array 24. No sensor hardware contact with the item being sensed is required. The laser triangulation sensors are able to reliably determine the standoff between each of the sensors circumferentially positioned around the tubular. Out of roundness or wear on a portion of the external surface may be detected, and information from all the sensors may be used to calculate the effective cross-sectional area and effective outer surface diameter of the string being monitored.

Using a non-contact sensor to measure stand-off has significant advantages compared to other techniques for correcting signals from magnetic flux sensors while at the well site in order to compensate for a varying stand-off between circumferentially spaced sensors and the string. Sensors which engage the string inherently engage couplings and connectors on the string, which impart shock, vibration, and damage to the sensors. Moreover, sensors intended for engagement with the string may engage a mud layer or paraffin layer on the external surface of the string, thereby producing erroneous correction signals. A transmitted beam sensor may distinguish between a metallic external surface of the string and mud or paraffin on the exterior surface of the string. The non-contact transmitted beam stand-off sensor is thus highly preferred for monitoring the stand-off as the string is pulled from the well.

The foregoing disclosure and description of the invention is illustrative and explanatory of preferred embodiments. It would be appreciated by those skilled in the art that various changes in the size, shape of materials, as well in the details of the illustrated construction or combination of features discussed herein maybe made without departing from the spirit of the invention, which is defined by the following claims.

What is claimed is:

1. An apparatus for detecting defects in an oilfield string at a well site as the string is pulled from the well, comprising:
a plurality of magnetic flux sensors circumferentially spaced about the string at the well site;
a plurality of stand-off sensors circumferentially spaced about the string at the well site for determining changes in a stand-off distance between one or more stand-off sensors and an external surface of the string, the stand-off sensor outputting a transmitted beam which hits the external surface of the string; and
a computer for correcting signals from the plurality of magnetic flux sensors as a function of the detected stand-off distance.

2. An apparatus as defined in claim 1, wherein each of the plurality of stand-off sensors comprises a laser triangulation sensor.

3. An apparatus as defined in claim 2, wherein each laser triangulation sensor includes a CCD array and image dispersion optics.

4. An apparatus as defined in claim 1, wherein one or more of the plurality of magnetic flux sensors includes a magnetic coil.

5. An apparatus as defined in claim 1, wherein one or more of the plurality of magnetic flux sensor includes at least one of a Hall Effect device and a Giant Magneto-Resistor.

6. An apparatus as defined in claim 1, wherein signals from the plurality of magnetic flux sensors and the plurality of stand-off sensors are correlated as a function of string depth in the well and the circumferential position of the sensors about the string.

7. An apparatus as defined in claim 1, further comprising:
a visual output for outputting the corrected signals from the computer.

8. An apparatus as defined in claim 1, further comprising:
a visual output for outputting indications of the stand-off between the magnetic flux sensors and the external surface of the string.

9. An apparatus for detecting defects in an oilfield string at a well site as the string is pulled from the well, comprising:
a plurality of magnetic flux sensors circumferentially spaced about the string at the well site for detecting flaws in the string, each magnetic flux sensor including a magnetic coil;
a plurality of laser triangulation sensors circumferentially spaced about the string at the well site for determining changes in a stand-off distance between one or more stand-off sensors and an external surface of the string; and
a computer for correcting signals from the plurality of magnetic flux sensors as a function of the detected stand-off distance.

10. An apparatus as defined in claim 9, wherein signals from the triangulation sensors and the plurality of stand-off sensors are correlated as a function of string depth in the well and the circumferential position of the sensors about the string.

11. An apparatus as defined in claim 9, wherein the string is one of a production tubing string and a sucker rod string.

12. A method of detecting defects in an oilfield string at a well site as the string is pulled from the well, the method comprising:
positioning a plurality of magnetic flux sensors circumferentially about the string at the well site;
providing a plurality of stand-off sensors circumferentially spaced about the string at the well site and outputting a beam which hits an external surface of the string for detecting changes in the stand-off distance between one or more of a plurality of stand-off sensors and an external surface of the string; and
correcting signals from the plurality of magnetic flux sensors as a function of the detected stand-off distance.

13. A method as defined in claim 12, wherein each of the plurality of stand-off sensors comprises a laser triangulation sensor.

14. A method as defined in claim 12, wherein the laser triangulation sensors each include a CCD array and image dispersion optics.

15. A method as defined in claim 12, wherein the plurality of magnetic flux sensors each includes a magnetic coil.

16. A method as defined in claim 12, wherein the plurality of magnetic flux sensors each includes one of a Hall Effect device and a Giant Magneto-Resistor.

17. A method as defined in claim 12, wherein signals from the plurality of magnetic flux sensors and from the plurality of stand-off sensors are correlated as a function of string depth in the well and the circumferential position of the sensors about the string.

18. A method as defined in claim 12, further comprising:
displaying an output of the corrected signals.

19. A method as defined in claim 12, further comprising:
displaying an output from the plurality of stand-off sensors.

20. A method as defined in claim 12, further comprising:
forwarding corrected signals from the plurality of magnetic flux sensors to a computer remote from the well site.
